(19) United States
(12) Patent Application Publication
(10) Pub. No.: US 2008/0307350 A1
(43) Pub. Date: Dec. 11, 2008

(54) Method and Apparatus for Improved Desktop Arrangement

(76) Inventors: Alessandro Francesco Sabatelli, San Francisco, CA (US); Pierre-Olivier Latour, Menlo Park, CA (US); Gregory Christie, San Jose, CA (US); Patrick L. Coffman, Menlo Park, CA (US); Imran Chaudhri, San Francisco, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/760,762

(22) Filed: Jun. 9, 2007

(51) Int. Cl. G06F 3/048

(52) U.S. Cl. 715/779; 715/810; 715/828

(57) ABSTRACT

A method and apparatus for organizing and viewing information in a data processing system is described. According to one embodiment of the invention, a group is created according to a predefined set of rules where the group contains a plurality of icons. The group is displayed on a desktop of the data processing system in a visually distinguishing manner. The group is expanded to display the plurality of icons within the group while a position of a cursor is in proximity to the group.

### FIELD OF THE INVENTION

The present invention relates to the field of data processing systems and more particularly to graphical user interfaces for data processing systems and to methods and apparatuses for implementing graphical user interfaces for organizing information in a data processing system.

### DESCRIPTION OF RELATED ART

Typical graphical user interface data processing environments include a desktop metaphor for management of files and launching of applications. For example, Apple's Macintosh, Microsoft Windows, and Linux data processing systems use a desktop metaphor. The desktop is usually the starting point for use of the data processing system. Similar to a physical desktop, a desktop in a graphical user interface data processing system allows a user to store items on the desktop. The desktop also often provides a means for a user to launch applications (e.g., toolbar, menu, etc.). The desktop may be considered to be a displayed region behind one or more windows, and this displayed region can receive icons (representing, for example, files, folders, or hardware devices) which are displayed in this displayed region. Often, the displayed region uses all of the display device's displayable area except for one or more menu bar(s), task bar(s) and dock(s).

Icons, which represent files in a file system, are commonly placed on the desktop. The icons may represent, for example, word processing files, application files, picture files, movie files, music files, spreadsheet files, or any other type of file common to data processing environments. Icons may be placed onto the desktop by the user or automatically by the data processing system. For example, a user may place icons on the desktop corresponding to user-created files while icons representing downloaded files may be automatically placed onto the desktop. A common approach of users to manage the desktop is to place icons that are most often wanted or place icons of temporal importance onto the desktop for quick and easy access.

Regardless as to how the icons are placed on the desktop, a desktop can quickly become filled with icons. FIG. 1A illustrates a desktop 100 that is cluttered with icons. The desktop 100 includes a plurality of icons 102_A . . . 102_Z, a folder 101_A and a toolbar 105. Although not shown for simplicity purposes, the desktop can also include other features, such as a clock, menu bar, etc. The plurality of icons 102_A . . . 102_Z on the desktop 100 may represent, for example, word processing files, application files, picture files, movie files, music files, spreadsheet files, database files, or any other type of file common to data processing environments. The desktop 100, in its current state as shown in FIG. 1A, is difficult for an average user to manage and use. For example, the icons 102_A . . . 102_Z may not be an adequate distance from one another to allow the user to distinguish between the icons. Thus, a user has a difficult time locating the desired icon. As another example, icons are commonly distinguished by icon name, if the icons are too close together, the icon names may overlap and become unreadable. A cluttered desktop not only frustrates the user but also increases the length of time required to find a wanted icon.

FIG. 1B is a block diagram illustrating a hierarchical filing system using a hierarchy of folders and/or subdirectories according to the prior art. In a folder system, a user will place an icon within a folder, which may be inside yet another folder, and so on. Thus, multiple icons may be stored within the folder, thereby saving space on the desktop. For example, the folder 101_A contains the folders 101_B, 101_C, and 101D and the icons 103_A . . . 103_Z. However, the icons (or folders) stored within a folder will not be accessible to the user on the desktop unless the folder is opened. A user may open the folder 101_A by positioning a cursor in proximity to the folder 101_A and providing input (e.g., click, double-click of mouse) or by using a keyboard, stylus, touchscreen, etc. As shown in FIG. 1B, a cursor 150 is positioned in proximity to the folder 101_A. Upon receiving input to open the folder 101_A, a window 111A is displayed. Window 111A reveals the icons and folders that are stored within the folder 101_A. Thus, the folders 101_B, 101_C, and 101_D and icons 103_A . . . 103_Z are stored within the folder 101_A. As can be seen, opening window 111_A obscures most of the icons on desktop 100. Users may navigate through the folders through windows. Opening a folder causes a window to be displayed which obscures portions of the desktop or the entire desktop.

As can be seen, a user may have to navigate through several layers of folders before locating the desired icon. For example, a user may have a folder on the desktop for music files and sub-folders within that music file folder representing different artists, and/or album names. A user wishing to locate a particular icon within the artist folder first has to open the music file folder to locate the artist folder. The user then opens the artist folder to locate the desired icon. Thus, one downside to placing icons in hierarchical folder systems is that a user may be required to navigate through a number of folders (and windows) before locating the desired file. Another downside to this approach is that a user will have to remember where the file is located, sometimes through a complex hierarchical path. Also, the user must often create these folders and sub-folders and place the icons within these folders. Because of these difficulties, many users store the majority of their icons in non-complex hierarchies (i.e., very few levels) or directly onto the desktop.

Another approach to managing a desktop arrangement is using a piles metaphor. An example of such an approach is described in U.S. Pat. No. 6,243,724, entitled METHOD AND APPARATUS FOR ORGANIZING INFORMATION IN A COMPUTER SYSTEM. There may be various piles located on the desktop. For example, there may be a pile that represents a ‘to-do’ pile, in-box, out-box, etc. FIG. 2 illustrates an in-box pile 220 located on the desktop (the desktop is not shown for the sake of simplicity). A user originally sees the in-box pile 220 as a stack of documents. Each document in the stack may represent a file. To locate a file within the pile 220, a user positions a cursor 250 in proximity to the stack of documents and, depending on the position of the cursor, a representation of the file will appear on the screen. Thus, since cursor 250 is located in proximity to file 205, file representation 215 appears on the desktop. However, since the files are stacked on top of each other, it is difficult to determine the content of a file before displaying a representation of that file. As a result, if the user determines that the file 205 is not the desired file, the user must move the cursor to another file in the pile in order to view a different representation, and so on, until the desired file is located. Increasing number of documents in a pile increases the likelihood that a user will have to navigate through the pile before locating the desired file.

Another feature common to graphical user interface data processing systems is some means to launch applications. Various methods of launching applications have been disclosed in the prior art. For example, one common approach is to include a toolbar on the desktop that contains application icons. The dock in the Macintosh 10.4 Operating System is an example of a user interface from which applications may be launched. These application icons represent application files and allow a user to launch applications directly from the toolbar. For example, a user can launch an application by positioning a cursor over the desired application icon in the toolbar and providing some kind of input (e.g., single or double click of a mouse, keyboard input, etc.). The toolbar in FIGS. 1A and 1B may be used in this fashion. For example, a user may launch the application associated to the application icon 105A by positioning a cursor in proximity to 105A and providing input indicating application launch. One drawback of using a toolbar in this fashion is that the toolbar is effectively limited in size thus limiting the number of application icons that may be placed on the toolbar. For example, application icons need to be large enough to be visible and distinguishable to a user and there is a desire not to occupy a significant portion of the desktop with the toolbar. Therefore, only a limited amount of application icons are typically found on toolbars of this fashion.

Another approach to launching applications is a menu based system. Typically there will be a button, icon, or link which when pressed or opened, presents the user with a menu. Within this menu there will be another button, icon, or link which when pressed or opened, presents the user with a list of applications. A user launches an application by selecting an application from this list or another list in a hierarchy of lists of applications. However, often the application is under several layers of hierarchy, similar to the hierarchical folder system.

FIG. 2B is a block diagram illustrating a menu based system for launching applications according to the prior art. A desktop 200 includes a menu bar 225. Within menu bar 225 is a link applications 225A. When the applications link 225A is selected, a menu 230 is created and displayed. The menu 230 includes a music player 240 and a video link 245. Upon selection of the music player 240 an application will launch that corresponds to music player 240. Upon selection of the video link 245 a menu 235 is created and displayed. The menu 235 includes a video player 260 and a video editor 265. As can be seen, if a user desires to launch the application that corresponds with video player 260, the user must navigate through a hierarchical set of menus.

### SUMMARY OF THE DESCRIPTION

Methods and apparatuses for organizing and viewing information in a data processing system are described. According to one embodiment of the invention, a group is created according to a predefined set of rules where the group contains a plurality of icons which may be referred to as a zone. The group is displayed on a desktop of the data processing system in a visually distinguishing manner. The group is expanded to display the plurality of icons within the group in response to a user command to expand, such as the positioning of a cursor in proximity to the group. In certain embodiments, when one group or zone is expanded, another group or zone previously expanded will be collapsed before or as the other group or zone is expanded so that only one group or zone, at any given time, is fully expanded. In certain other embodiments, a preview of one or more of the files within a group or zone may be obtained, in response to a user command, while the group or zone is expanded.

In another aspect of the present inventions, certain embodiments include an expandable display region, such as an expandable dock or expandable toolbar which includes icons for launching applications (and potentially includes icons for opening folders or files). The display region is associated with a particular edge of a display screen (e.g. it is displayed adjacent to a display screen's edge or on the edge itself), and the display region includes an expand command, which when selected, causes the display region to expand to display at least a subset of icons representing launchable applications programs not already displayed on the display region before expanding the display region.

In at least certain embodiments, the zones represent a plurality of desktops which are available for browsing and use by a single, logged in user.

Machine readable media and data processing systems and other methods are also described.

### BRIEF DESCRIPTION OF THE DRAWINGS

The invention may best be understood by referring to the following description and accompanying drawings that are used to illustrate embodiments of the invention. In the drawings:

FIG. 1A shows a block diagram illustrating a desktop on a data processing system that is cluttered with icons according to the prior art.

FIG. 1B shows a block diagram illustrating a desktop on a data processing system that shows a folder hierarchy system with a window obscuring icons on the desktop according to the prior art.

FIG. 2A shows a block diagram illustrating a piles metaphor for managing icons on a desktop on a data processing system according to the prior art.

FIG. 2B shows a desktop on a data processing system with a menu based system for launching applications according to the prior art.

FIG. 3A shows an example of a desktop on a data processing system that includes a plurality of zones and a toolbar with an expansion command according to one embodiment of the invention.

FIG. 3B shows an example of the toolbar of FIG. 3A in expanded mode according to one embodiment of the invention.

FIG. 3C shows an example of the desktop of FIG. 3A with one of the zones expanded according to one embodiment of the invention.

FIG. 4 shows a detailed view of the expanded zone in FIG. 3C according to one embodiment of the invention.

FIG. 5 shows an example of searching a plurality of zones on a desktop of a data processing system according to one embodiment of the invention.

FIG. 6 shows a block diagram illustrating creation of a zone upon a file being downloaded according to one embodiment of the invention.

FIG. 7 is a flow diagram illustrating a method of organizing and viewing information in a data processing system according to one embodiment of the invention.

FIG. 8A is a flow diagram illustrating exemplary operations of displaying zones on a desktop where the zones are expanded and a file is previewed according to one embodiment of the invention.

FIG. 8B is a flow diagram illustrating exemplary operations of adding an icon to a zone according to one embodiment of the invention.

FIG. 9 is a flow diagram illustrating searching the zones for icons in response to a user search query according to one embodiment of the invention.

FIG. 10 is a flow diagram illustrating launching an application with an expanded toolbar according to one embodiment of the invention.

FIG. 11 shows exemplary data structures, maintained in one or more machine readable media, for managing desktop zones relative to a traditional hierarchical file system (HFS).

### DETAILED DESCRIPTION

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

The techniques shown in the figures and described herein can be implemented using code and data stored on machine-readable medium and executed on data processing systems. The data processing system typically includes a processor (or set of processors) and a memory and an input device and a device for presenting a user interface, such as a display device and/or an audio transducer (e.g. a speaker). Examples of such data processing systems include general purpose computers or special purpose computers or personal digital assistance (PDAs) or cellular telephones, etc. Examples of data processing systems are shown and described in U.S. Pat. No. 6,222,549 which is hereby incorporated herein by reference. A machine-readable medium includes any mechanism that provides (i.e., stores and/or transmits) information in a form readable by a machine (e.g., a data processing system). For example, a machine-readable medium can include storage media (e.g., a read only memory (ROM); random access memory (RAM); magnetic disk storage media; optical storage media; flash memory devices;) or communications media (e.g., electrical, optical, acoustical or other form of propagated signals (e.g., carrier waves, infrared signals, digital signals, etc.)); etc. Of course, one or more parts of the invention may be implemented using any combination of software, firmware, and/or hardware.

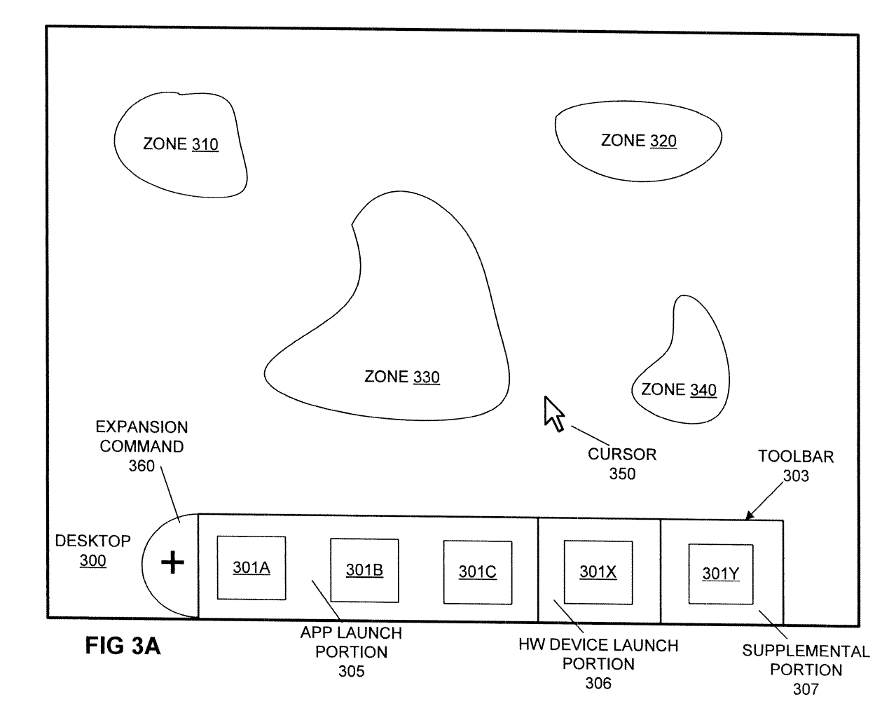

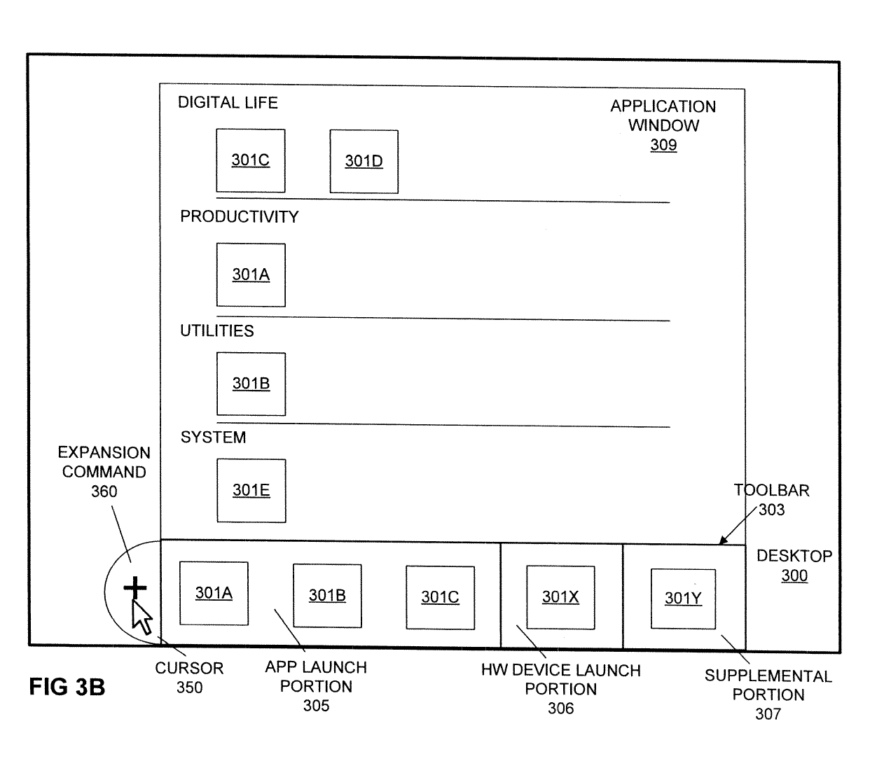

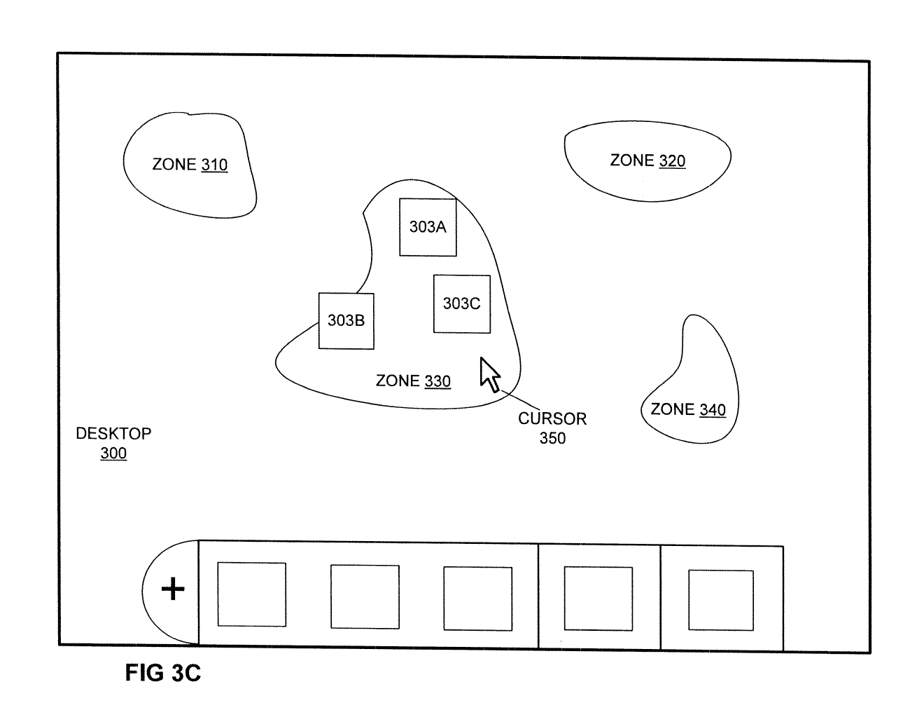

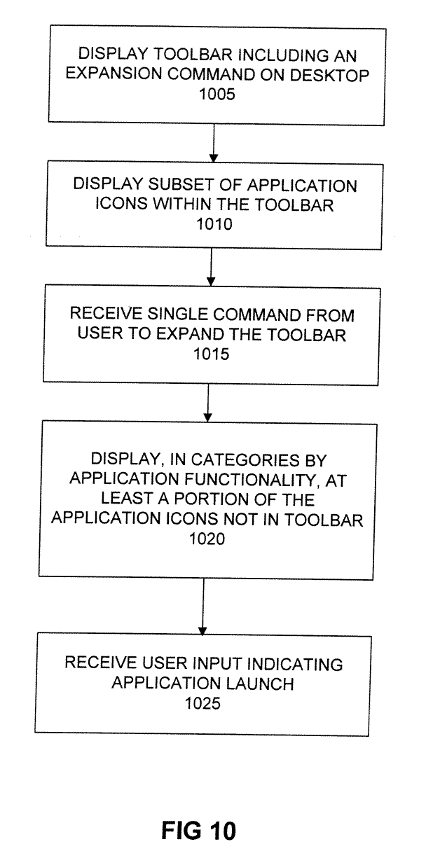

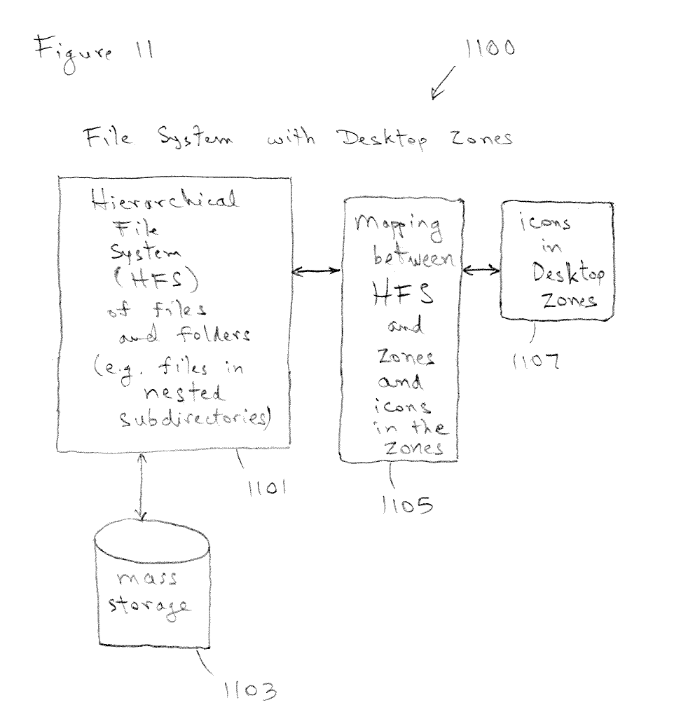

FIG. 3A shows one exemplary desktop arrangement using a plurality of zones and an expansion command enabled toolbar or dock to manage the desktop arrangement according to one embodiment of the invention. The desktop 300 includes zones 310, 320, 330, and 340. The zones 310, 320, 330, and 340 each conceal one or more icons. The number of zones in FIG. 3A is illustrative as there can be any number of zones on the desktop. Also displayed on the desktop 300 is a toolbar 303 that includes application launch portion 305, hardware device launch 306, supplemental portion 307, and expansion command 360. The toolbar 303 will be described in greater detail in reference to FIGS. 3B and 10.

In one embodiment of the invention, zones are created and added automatically to the desktop by the data processing system without intervention by the user. The data processing system may create any number of zones. For example, a download zone storing icons representing downloaded files may be created. Additionally, the data processing system may create one or more zones that contain icons of a certain file type (e.g., a word processing zone, spreadsheet zone, database zone, portable document file (PDF) zone, movie zone, music zone, etc.). As another example, the data processing system may create one or more temporal zones (e.g., a most recently used file zone, recently modified file zone, used this month zone, used this week zone, used this day zone, etc.). A zone representing items to be written to storage media may also be created and added to the desktop by the data processing system. A zone representing networked computers may also be created and added to the desktop by the data processing system.

In addition to the data processing system creating and adding zones to the desktop, the data processing system may provide a user the capability to create and add user-defined zones to the desktop and to add files to zones already created, such as zones created automatically by the data processing system. As an example, the data processing system may present the user a window where placing at least two icons within the window creates a zone. Additionally, zones may created by the system in response to a user placing an icon in proximity (i.e., some predetermined distance) to a different icon. Thus, the data processing system provides a user the capability to create user-defined zones.

According to one embodiment of the invention, icons for files are sorted and placed into zones according to a predefined set of rules. These rules may be predefined by the system and/or by the user and these rules may be relaxed manually or automatically to include or exclude icons/files. For example, system predefined rules may cause icons of a certain file type to be placed into a separate zone corresponding to that file type (e.g., a word processing zone, a spreadsheet zone, database zone, portable document file (PDF) zone, movie zone, music zone, etc.). Other system predefined rules may cause icons of a temporal nature to be put into one or more temporal zones (such as, for example, a download zone). Additionally, system predefined rules may cause icons representing items to be written to media to be placed within a separate zone (such as a “burn zone”). Alternatively or additionally, users may define rules or modify the system predefined rules to place icons into separate zones.

The system predefined rules may be applied to icons upon file creation. In other words, the system predefined rules may be dynamically and automatically, without user intervention, applied to icons when the files (and their corresponding icons) are added to the data processing system. After the system predefined rules are applied to the icons, any user defined rules are then applied to the icons. This may cause icons to exist in more than one zone. For example, a PDF icon may be placed into a PDF zone in accordance with the system predefined rules and placed into a user defined zone in accordance with the user defined rules. In another embodiment of the invention, icons exist in a single zone only. In this situation, user defined rules may be applied to the icons before the system predefined rules are applied. If the user defined rules cause an icon to be placed into a zone then the system predefined rules are not applied. This effectively provides priority to user defined rules. For example, if an icon is placed into a zone in accordance with the user defined rules then the system predefined rules are not applied.

Additionally, the data processing system provides a user with the capability to save icons to a zone. For example in one embodiment, the ‘save as’ or save window displayed by a data processing system includes the zones that are currently defined (e.g., the ‘save as’ window includes all the zones that currently exist). In another embodiment, a save or save as window may reveal the desktop in, for example, a side bar region of the window, and a user may then browse the zones on the desktop, from within the save or save as window and select a zone to add the icon to. By placing zones in the ‘save as’ or save window, the user has the capability to save items directly into a zone. Additionally, the ‘save as’ window may also include an option to create a new zone. Certain file types are automatically added to zones in accordance with system defined rules. Thus, not every zone needs to be included in the ‘save as’ dialog. Therefore, in an alternative embodiment, the ‘save as’ dialog includes a certain subset of zones (e.g., user defined zones, user defined and items to be written zones, etc.). For example, a word processing icon is automatically added to a word processing zone by the data processing system, thus the word processing zone need not be displayed in the ‘save as’ dialog. However, the user may want to save the word processing item in a user defined zone, such as a project zone. In certain other embodiments, the “save as” dialogs and “open” dialogs may, in addition to displaying the zones which contain representations of files, also display folders maintained in a hierarchical file system such as the Macintosh HFS systems. Hence, a user may use both desktop zones and a traditional file system based on folders.

The zones 310, 320, 330, and 340 are identified in a visually distinguishable manner on the desktop (e.g., by one or more of a unique shape, graphic, color, text label, etc.). Additionally, the zone shape may be embedded into the desktop background. Additionally, the zones may visually approximate the number of icons found within the zone and/or may visually approximate other characteristics of the zone or icons/items within the zone (e.g. the age of icons in the zone, etc). For example, the color or shading or size of a zone may depend upon the number of icons concealed within that zone. Alternatively or additionally, the size and shape of a zone are in relation to the amount of icons found within that zone (e.g., the size of the zone increases as the number of icons within the zone increases). Therefore in one embodiment, the color and/or shape of a zone changes dynamically according to additions or subtractions of icons within the zone allowing a user to visually approximate the number of icons within a zone.

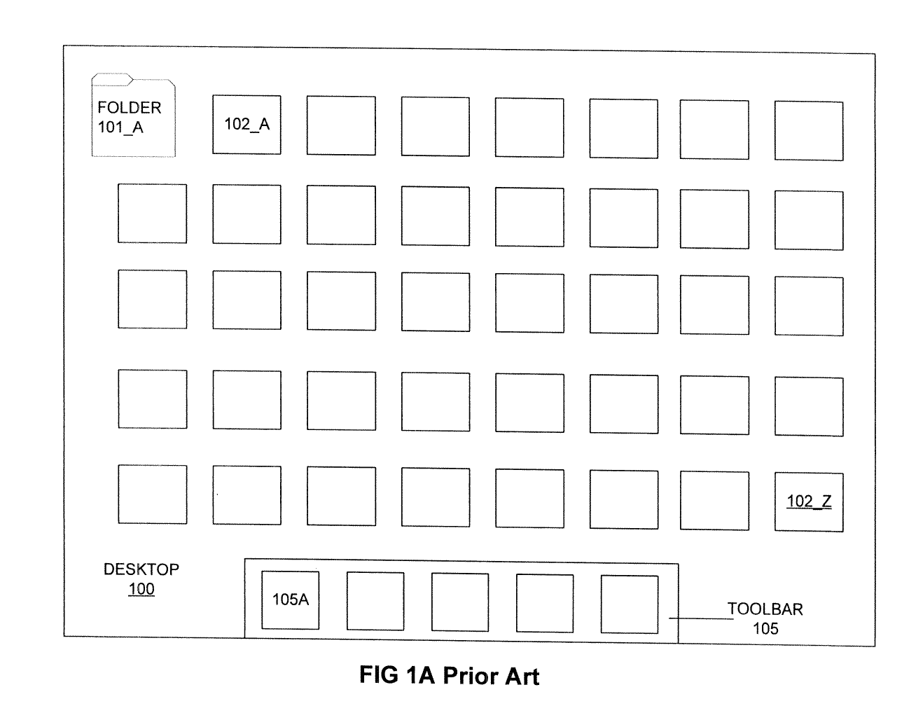

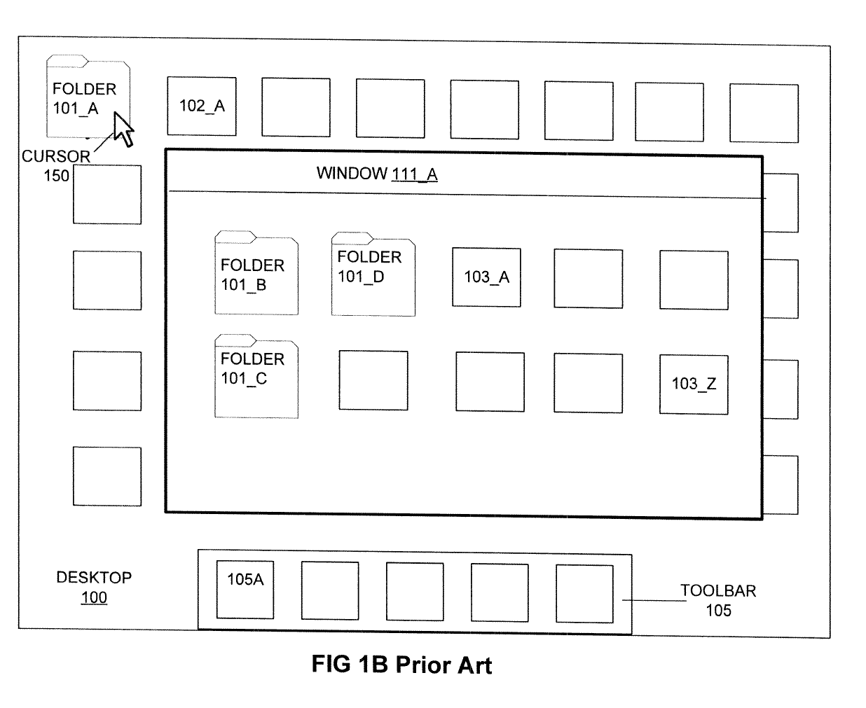

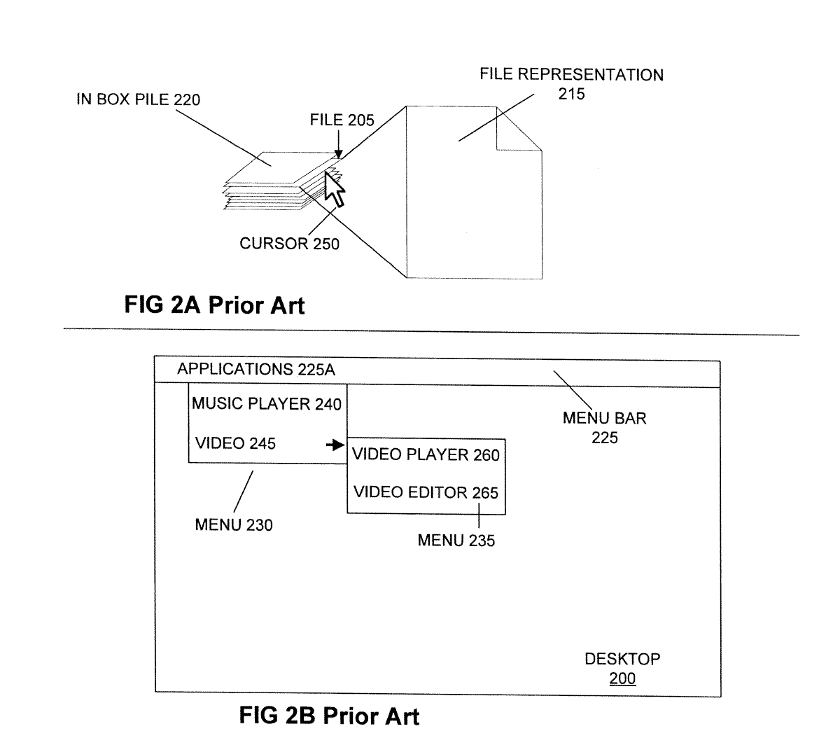

While FIG. 3A does not show folders, according to one embodiment, a combination of folders and zones may be displayed on the desktop. Thus, a user may employ a hybrid desktop that includes folders (in a traditional hierarchy of folders) and zones. It will be appreciated that the use of desktop zones will not preclude, in at least certain embodiments, the user of an underlying hierarchical file system (HFS), such as the Macintosh HFS+ or other types of file systems which support a hierarchy (e.g. nested subdirectories and files within the nest subdirectories, for example, as shown in FIG. 1B in which several folders, each containing files, are contained within another folder). In other words, an HFS and desktop zones may coexist and a user may make use of only one or both systems to store files. In a typical implementation, shown in FIG. 11, a hierarchical file system 1101 will exist to support the storage and use of files in a mass storage 1103, and hence directories and at least one file system database and file allocation table are maintained and used by the hierarchical file system to keep track of the files nested in subdirectories (either created by the user or by the system). In addition, such a hierarchical file system 1101 will prove a mapping, such as mapping 1105, between the files (and their corresponding icons) in the HFS and the desktop zones and the icons in the desktop zones. This mapping will typically specify a correspondence between each icon within a zone and a particular corresponding file in the HFS, and hence it is possible that the same file may have a corresponding icon in several zones. In addition, the HFS will maintain information about each zone. The use of an HFS with desktop zones may give at least certain users greater flexibility in using a data processing system while reducing desktop clutter. For example, a file management software program such as the Finder from Apple Inc. may provide user interfaces to browse and manipulate the files in the HFS, and this type of program may be made available to the user in addition to making desktop zones (and/or other aspects or embodiments described herein) available to the user.

FIG. 3B shows a block diagram illustrating the toolbar of FIG. 3A in expanded mode according to one embodiment of the invention. As previously described, the toolbar 303 includes an application launch portion 305, a hardware device launch portion 306, a supplemental portion 307, and an expansion command 360. Application launch portion 305 typically includes commonly used application icons which may be placed in the toolbar by the system or by the user. Additionally, the data processing system provides the user the capability of adding or removing application icons from the application launch portion 305.

According to one embodiment, receipt of a single user command causes the toolbar 303 to expand. For example, a cursor 360 is positioned in proximity to the expansion command 360 (e.g., within a few pixels, adjacent to, over, etc.) causing the toolbar 303 to expand. Alternatively the user command may be from a keyboard, a mouse button, stylus pen input, touchscreen input, etc. According to one embodiment the expanded toolbar is displayed as application window 309. Once opened, the application window 309 may be closed in numerous ways (e.g., the position of cursor 360 not being in proximity to the expansion command 360, receipt of user command, etc.). In another embodiment, once the cursor is positioned in proximity to the expansion command 360, a single additional command is required to expand toolbar 303 (e.g., a single or double click of a mouse button, keyboard input, etc.).

Application window 309, in addition to including application icons in application launch portion 305, also includes application icons not present in application launch portion 305. For example, application window 309 contains application icons 301D and 301E which are not present in application launch portion 305. While in one embodiment application window 309 includes icons present in application launch portion 305, other embodiments of the application window 309 include only application icons which are not present in application launch portion 305. In other words, the application window 309 displays at least a subset of icons representing launchable application programs not already displayed in the application launch portion 305.

The application window 309 categorizes the application icons according to application functionality according to one embodiment. The categories illustrated in application window 309 are exemplary as any number of different categories may be used. For example, icons 301C and 301D are categorized as digital life applications (e.g. applications for managing and using music, photographs, movies, etc.). Icon 301A is categorized as a productivity application (e.g. a word processing program). Icon 301B is categorized as a utilities application (e.g. a disk repair program). Icon 301E is categorized as a system application. According to one embodiment of the invention, an application is categorized by metadata associated with the application. Thus, if a new application is installed, the data processing system categorizes this new application by the new application's associated metadata. Categorizing application icons within application window 309 provides the user with a quick means of locating a desired application for a desired task. Thus, instead of requiring users to remember the names of application, users can locate an application by category. This is especially helpful if the user is unfamiliar with names of the applications. In certain embodiments, the data processing system includes searching capabilities, such as those provided by Spotlight from Apple Inc. that allow a user to search through or for applications, files and other data on the data processing system and these capabilities can be provided to search through the dock and zones also. The searching may be focused or limited to searching of just the dock and/or zones or may be directed to perform searching of the zones and/or dock and other locations in a file system of the data processing system. Further information about such search capabilities may be obtained from published PCT Application No. WO 2006/004670, published on Jan. 12, 2006, which application is hereby incorporated herein by reference.

Applications may be launched from application window 309 in any number of ways. For example, a cursor may be positioned in proximity to an application launch icon (e.g., within a few pixels, adjacent to, over, etc.) and an additional input (e.g., mouse input, keyboard input, etc.) may signal application launch. Alternatively, a user may indicate application launch without using a cursor. For example, a user may ‘tab through’ the application icons in the expanded toolbar using the tab key of a keyboard (or any other predefined keyboard key assigned for this task such as the arrow keys on a keyboard). The currently selected icon is illuminated in such a fashion to alert the user which icon is currently selected. The user then provides additional keyboard input or other input (e.g. a spoken command) indicating application launch (e.g., pressing the enter key). Alternatively still, the user may be using a touchscreen data processing device where pressing on a screen in a location proximate to an application icon may indicate application launch.

As previously described, the toolbar 303 may also include hardware device launch 306. Hardware device launch 306 includes hardware device icon 301X. Hardware device 301X may be a device of any number of hardware devices (e.g., camera, printer, scanner, music player, flash drive, external storage, etc.). According to one embodiment, hardware device icons are dynamically added to hardware device launch 306 upon hardware device initialization. For example, upon a user connecting a hardware device (e.g., camera, printer, scanner, music player, flash drive, external storage, etc.) an associated hardware device icon will be dynamically added to hardware device launch 306. This provides the user with a quick means of accessing the hardware device connected to the data processing system. In an alternative embodiment, the hardware device launch portion 306 may be disposed on the desktop 300 rather than, or in addition to, being in toolbar 303.

Toolbar 303 also includes supplemental portion 307 which includes icon 301Y. Supplemental portion 307 may be used by the data processing system to place icons that do not belong in the application launch portion 305 or the hardware device launch 306. For example, the supplemental portion 307 may include an icon representing items to be removed from the data processing system. Additionally or alternatively, zones and/or folders or files may be placed into supplemental portion 307 by the user or by the system.

FIG. 3C shows a block diagram illustrating the desktop of FIG. 3A with zone 330 being expanded according to one embodiment of the invention. The zone 330 in its expanded form allows icons 330A, 330B, and 330C to be displayed. In other words, the zone 330 in its expanded form reveals icons it previously concealed from being displayed. In certain embodiments, a zone which is not expanded may only partially conceal icons contained within the zone. As previously described, the zone 330 can represent any number of different system-defined zones or user-defined zones(e.g., download zone, file type zone, temporal zone, to be written to storage media, user defined, etc.). Icons 330A, 330B, and 330C can be icons representing a file of any number of files (e.g., word processing files, application files, picture files, movie files, music files, spreadsheet files, database files, or any other type of file common to data processing systems).

According to one embodiment, the zone 330 is expanded in response to a command such as the position of the cursor 350 being in proximity to the zone 330 (e.g., within a few pixels, adjacent to, over, etc.). Alternative embodiments require an additional command from a user to expand zone 330, such as a single or double click of a mouse button, keyboard input, stylus pen input, touch screen input, etc. Alternatively, the zone 330 may be expanded without using a cursor. For example, a user may ‘tab through’ the zones by using the tab key of a keyboard (or any other predefined keyboard key assigned for this task). The currently selected zone will be illuminated in such a fashion to indicate to the user which zone is currently selected. The user then provides additional input, such as keyboard input indicating zone expansion (e.g., pressing the enter key). Alternatively still, when using a touchscreen data processing device, a user may indicate zone expansion by pressing on the touchscreen in a location proximate to the zone.

In one embodiment, all icons within a zone are displayed once the zone is expanded. However, displaying all icons within a zone may be burdensome to the user. For example, there may be many icons within a zone, thus displaying every icon within the zone may overwhelm the user. Also, icons that are used rarely or have been not been used in a relatively long period usually need not be displayed to the user or they may be displayed in a de-accentuated manner (e.g. a smaller size or greater transparency). Thus, in alternative embodiments, a certain subset of icons within the zone will be displayed in the expanded zone and a user may “flip” through pages of the zone to reveal all of the subsets, or pages of the zone may be presented in list view(s) or one scrollable page of the zone may be presented in a list view. For example in a download zone, icons which have been downloaded most recently will be displayed once the zone is expanded while “older” icons that were downloaded least recently will not be displayed initially in the expanded zone. However, according to one embodiment, icons that are not displayed in the expanded zone and are located within the zone are not removed from the zone. In other words, an icon not displayed initially in the expanded zone may still exist within the zone, but will require additional user input to display those icons not initially displayed. Therefore, the data processing system provides the user with any number of ways to display or reorder the icons within the zones (e.g., by icon name, by icon creation date, by last used date, by last modified date, etc.). The option provided to users to display or reorder the icons may be done any number of ways (e.g., a drop down menu in the zone, properties menu of the zone, mouse gestures within the zone, etc.). Furthermore, the zones may include a tabbed (or paged) browsing of icons where sets of icons are arranged into tabs (or pages). As an example, if icons cannot fit on a first tab (page) they are placed in a second (tab) page. A user may then select the tab (or page) to display the icons that were not initially displayed in the expanded zone. In other words, the data processing system may distribute the icons through pages providing the user with quick means of browsing through a large amount of icons within a zone.

The size of an expanded zone may be different than the size of the zone in its unexpanded form according to one embodiment. Thus, if the number of icons within the zone is such that the icons cannot be displayed within the current size of the zone, the zone may be temporarily enlarged in order to display the icons. Therefore, temporarily, other zones on the desktop may be obstructed by the newly enlarged zone. When the zone is collapsed, the size of the zone will return to its previous state. In another embodiment, when the zone is collapsed, it will return to a state which is partially in line with its pervious state. As an example, the zone could be shrunken down to make room for the newly expanded zone. It would look like itself, but its size would be different.

An expanded zone may be collapsed by any number of different mechanisms. For example, in FIG. 3C, the expanded form of zone 330 may be collapsed upon a position of the cursor 350 moving from being in proximity to zone 330 to any other area in the desktop 300. Alternatively, in addition to the position of the cursor 350 moving from being in proximity to zone 330 to any other area in the desktop 300, another input command is required from the user (e.g., mouse click, keyboard command, stylus pen input, touch screen, mouse gesture, etc.). Furthermore, the zone 330 may include a portion which when clicked on collapses the zone, or may be collapsed at any time given a keyboard input.

According to one embodiment, only one zone is fully expanded at a given time. Thus, if zone 330 is expanded (as show in FIG. 3C) zones 310, 320, and 340 must not be fully expanded. Alternatively, more than one zone may be open at a time as long as neither zone obscures the other zone.

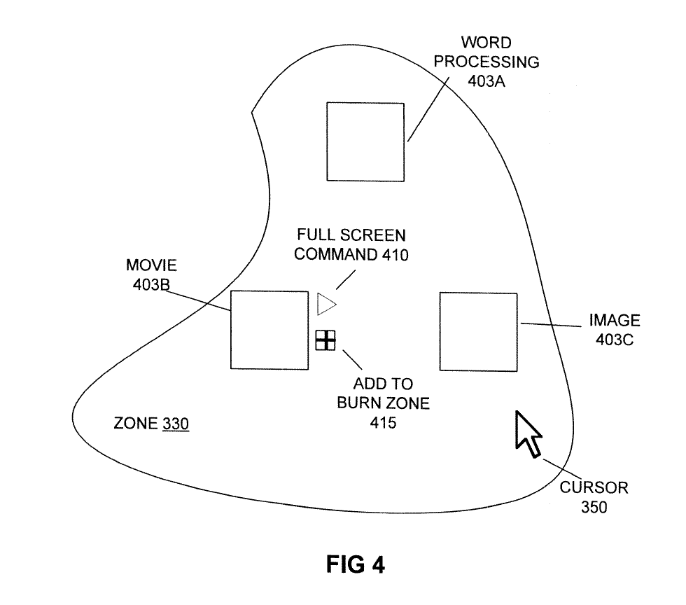

FIG. 4 shows a block diagram illustrating a detailed view of the expanded zone in FIG. 3C according to one embodiment of the invention. Word processing icon 403A, movie icon 403B, and image icon 403C are displayed in expanded zone 330. According to one embodiment, icons for certain common file operation commands are placed adjacent to an icon in the expanded zone. For example, adjacent to movie icon 403B are full screen command 410 and add to burn zone 415. Upon receiving user input initiating full screen command 410 (e.g., mouse click, keyboard command, stylus pen input, touch screen, mouse gesture, etc.), the movie file represented by movie icon 403B will be opened and displayed in a full screen format. Upon receiving user input initiating add to burn zone 415, the movie icon 403B will be added to a zone that contains icons representing files to be written to a storage media, such as a CD-R (recordable compact disk). The common file operation commands that are adjacent to movie icon 430B are exemplary, as any number of file operation commands may be placed next to icons (e.g., delete, remove from zone, play, send in email, print, etc.).

A preview mechanism, in at least certain embodiments, is initiated by the data processing system upon receiving user input indicating selection of an icon. For example, upon a position of the cursor 350 being in proximity to word processing icon 403A (e.g., within a few pixels, adjacent to, over, etc.) a full page preview will be displayed on the desktop. The full page preview displays actual pages from the word processing file associated with word processing icon 403A. As another example, upon a position of the cursor 350 being in proximity to image icon 403C (e.g., within a few pixels, adjacent to, over, etc.) a large preview of the image file represented by image icon 403C is displayed on the desktop. It is understood that the preview mechanism may be different for different file types. For example, word processing files may be previewed by displaying the first page of the file while movie files may be previewed by playing the movie.

Files that are represented by icons in the expanded zone 330 are opened in response to receiving user input indicating the data processing system to open the file. Typically, a user uses a pointing device (e.g., mouse, stylus, etc.) to position a cursor in proximity to an icon and subsequently provides input (e.g., mouse single click or double click) which causes the data processing system to open the application and file represented by that icon. A user may also use the keyboard or other input devices to provide user input. For example, within the expanded zone, a user may ‘tab through’ the icons using the tab button (or any other predefined keyboard button). The currently selected icon is illuminated in such a fashion to alert the user which icon is currently selected. The user then provides additional keyboard input indicating the data processing system to open the file (e.g., by pressing the enter key).

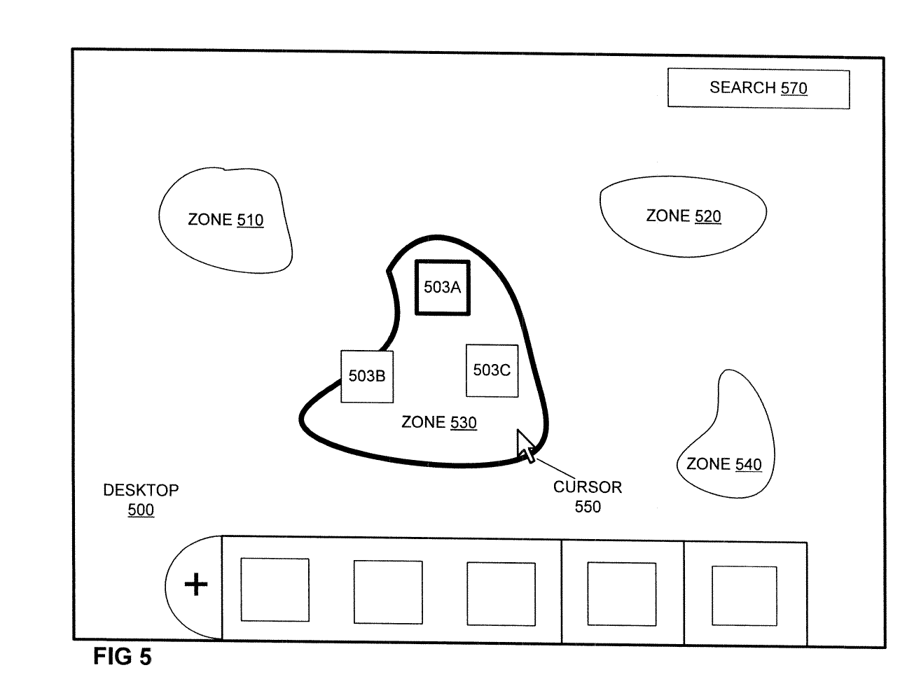

FIG. 5 shows a block diagram illustrating a method of searching a plurality of zones on a desktop of a data processing system according to one embodiment of the invention. The desktop 500 includes the zones 510, 520, 530, and 540. A search field 570 is built into the desktop 500 (i.e., the search field 570 is embedded onto desktop 500), and the search field is designed to receive a user's search query and to then cause the system to perform a search. The search field 570 searches the zones for icons in response to a user query entered into search field 570. The search which results from use of search field 570 may be limited to searching the zones or may also search, in addition to the zones, files in the HFS. Any search algorithms known in the art may be used to perform the search of the zones.

Search results may be conveyed to the user in numerous ways. According to one embodiment, zones that contain icons which match the search query are illuminated (e.g., visually stand out to the user). In this fashion, the user quickly knows which zone contain icons which match the search query. Icons within the zone that match the search query are also illuminated upon the zone being expanded. The illumination may take any number of forms (e.g., glow, sparkle, or any other visual cues). FIG. 5 shows expanded zone 530 as being illuminated in response to a search query. The icon 503A is also illuminated within expanded zone 530. Thus, icon 530A matches the search query entered into search field 570.

According to an alternative embodiment, upon locating icons which match the search query, the data processing system creates a new zone for icons that match the search query (e.g., a search result zone). The icons are added to the search result zone and the zone is displayed on the desktop. The user may then use this zone in the same fashion as other zones. For example, the user may expand the zone to view the search results (e.g., to view the icons within the zone which match the search query). The data processing system also gives the user the option to save or dismiss the search zone.

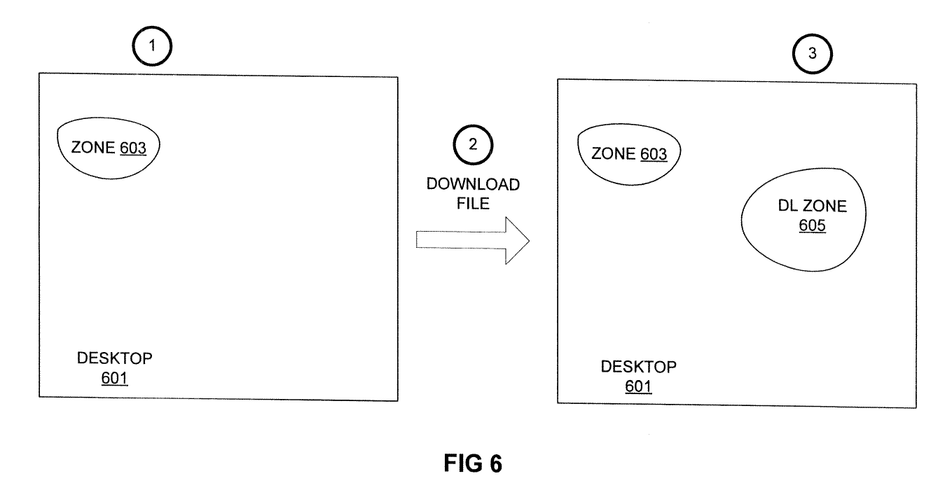

FIG. 6 shows a block diagram illustrating creation of a zone upon a file being downloaded according to one embodiment of the invention. At a time 1, the desktop 601 includes zone 603. The zone 603 may be any type of zone other than a recently downloaded zone (e.g., system defined zone, user defined zone, etc.) At a time 2, a file is downloaded. Typically, a file is downloaded through a network (e.g., local area network, Internet, etc.). According to one embodiment, icons which represent files downloaded are automatically placed within a download zone. If a download zone does not exist, one is created, and then the icons representing downloaded files are added there. At a time 3, a download zone 605 is created and an icon representing the downloaded file from time 2 is added to the download zone 605.

In an alternative embodiment, only certain icons will be placed into download zone 605. For example, the data processing system identifies the type of file downloaded and determines whether to place an icon representing that file in the download zone 605. If the file downloaded is of a type that a user generally does not need access to, then the icon representing the file will not be added to the download zone 605. For example, if the user downloads a new font or application installation file, the data processing system will install the font or application and does not add an icon representing the font or application install file to the download zone 605. In one embodiment the data processing system determines whether to place an icon into download zone 605 by the file extension or other associated metadata of the downloaded file.

Icons are not removed from the download zone automatically by the data processing system. However, as the amount of downloaded files can become large with continued use of the data processing system, the newest files downloaded are given priority over the older files downloaded. In other words, the icons which represent files that were downloaded most recently are displayed in the expanded download zone before the other icons. Additionally or alternatively, the newer icons have a visual cue indicating to the user which file was downloaded most recently. As previously described, the data processing system also provides the user the capability to display or order the icons within a zone in any number of ways (e.g., by icon name, by icon creation date, by last used date, by last modified date, etc.). In certain embodiments, a history playback (e.g. a history viewer) mechanism may allow a user to see the state of a zone over time.

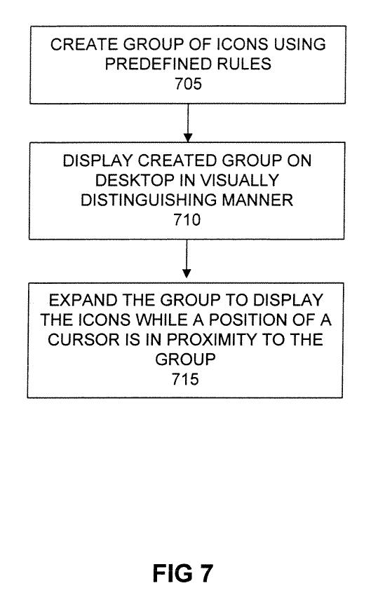

FIG. 7 is a flow diagram illustrating a method of organizing and viewing information in a data processing system according to one embodiment of the invention. At block 705 a group containing icons are created using predefined rules. While in one embodiment the predefined rules are system predefined rules, in alternative embodiments the predefined rules are user defined rules. After the group is created control flows to block 710.

At block 710 the group is displayed on the desktop in a visually distinguishing manner. As previously described, the group can be displayed in a visually distinguishing manner in any number of ways (e.g., by a unique shape, graphic, color, text label, etc.). After the group is displayed on the desktop, control flows to block 715 where the group is expanded to display the icons while a position of a cursor is in proximity to the group.

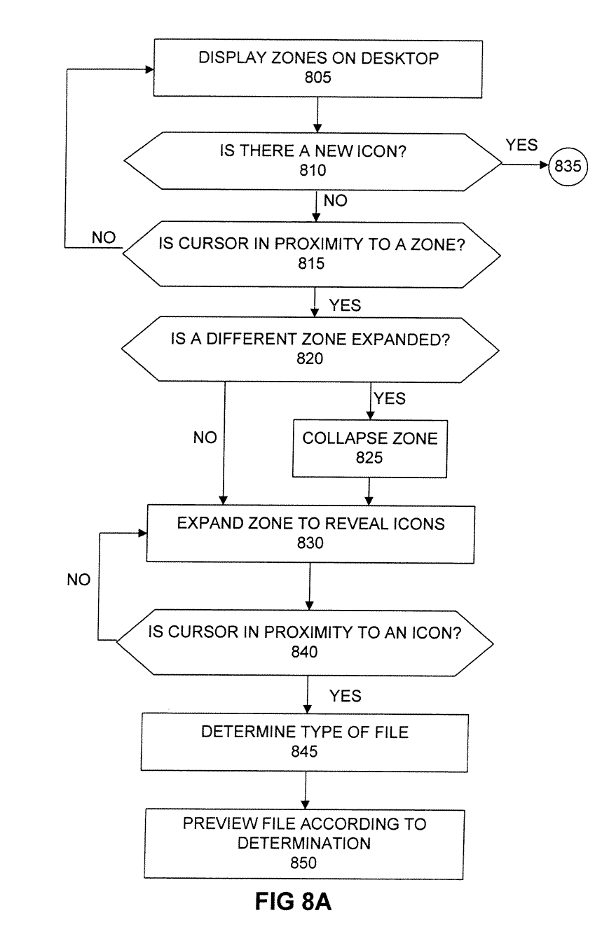

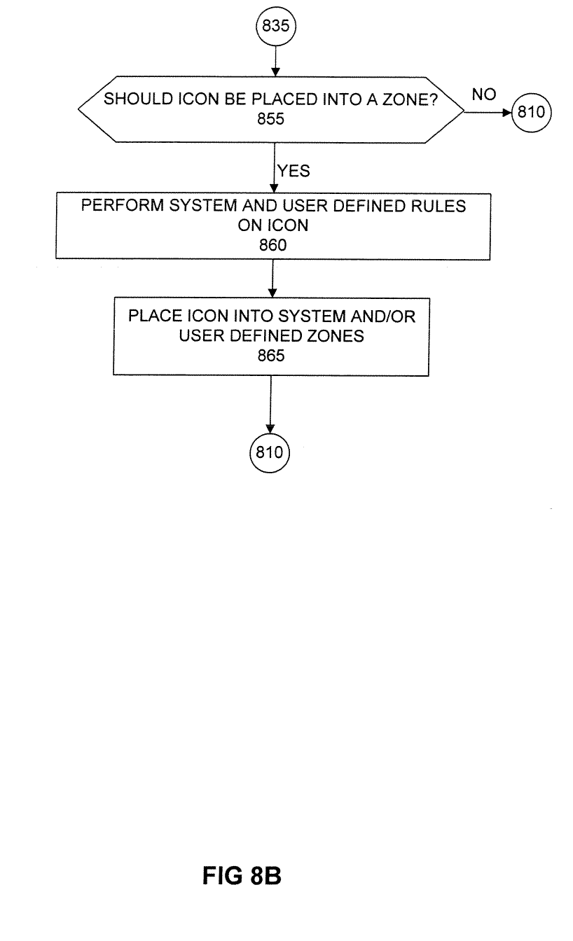

FIG. 8A is a flow diagram illustrating exemplary operations of displaying zones on a desktop where the zones are expanded and a file is previewed according to one embodiment of the invention. At block 805, multiple zones are displayed on the desktop. For example, with reference to FIGS. 3A and 3C, zones 310, 320, 330, and 340 are displayed on the desktop.

At block 810 a determination is made whether there is a new icon added to the data processing system. For example, a new icon to the data processing system may be added in response to a user downloading a file from a network (e.g., local area network, Internet, etc.) or by a user creating a new file (e.g., a user creating a word processing file). If the data processing system determines a new icon has been added to the data processing system, control flows to block 835 which is described in greater detail in FIG. 8B. If the data processing system determines that no icons have been added to the data processing system, control flows to block 815.

At block 815 a determination is made whether a cursor is in proximity to a zone (e.g., within a few pixels, adjacent to, over, etc.). If the cursor is in proximity to a zone, control moves to block 820, otherwise control moves back to block 805. In reference to FIG. 3A, cursor 350 is not in proximity to any zone. By contrast, cursor 350 in FIG. 3C is in proximity to zone 330.

At block 820 a determination is made by the data processing system whether a zone (other than the zone the cursor is currently in proximity to) is expanded. In other words, the data processing system determines if a different zone is already in expanded mode on the desktop. According to this embodiment, only one zone may be open at a time, thus any zones that are opened will be collapsed at block 825 and control flows to block 830. If no other zones are expanded, control flows to block 830.

At block 830 the zone the cursor is currently in proximity with will be expanded to reveal the icons within that zone. With reference to FIG. 3C, the zone 330 is expanded revealing icons 303A, 303B, and 303C. After the zone is expanded, control flows to block 840 where a determination is made whether a cursor is in proximity to an icon. If the cursor is in proximity to an icon, control flows to block 845.

At block 845 the data processing system determines the type of file the icon represents and control moves to block 850. At block 850 a preview of the file is displayed on the desktop according to the determination made in block 845. Different file types may be previewed on the desktop differently. For example, word processing files may be previewed by displaying the first page of the file while movie files may be previewed by playing the movie.

Referring to block 835, control flows to block 855 where the data processing system determines if the new icon should be placed into a zone. In one embodiment, not all icons are placed into a zone in order to minimize clutter within the zone. For example, if the user downloads a new font or application installation file, the data processing system will install the font or application and does not add the icon to a zone. According to one embodiment the data processing system determines whether to place an icon into a zone by metadata associated with the icon. If the data processing system determines that the new icon should not be placed into a zone, control flows to block 810, otherwise control flows to block 860.

At block 860, system and user defined rules are performed on the icon. As previously described, the system has defined rules to sort and place icons into one or more zones. For example, a new word processing icon may be placed into a word processing zone according to the system defined rules. Also previously described, the user has the capability to define rules to place icons into one or more zones. For example, the data processing system allows the user to save files directly into zones with a ‘save as’ dialog. At block 865 the icons are placed into the system and/or user defined zones in accordance with the performance of block 860 and control flows to block 810.

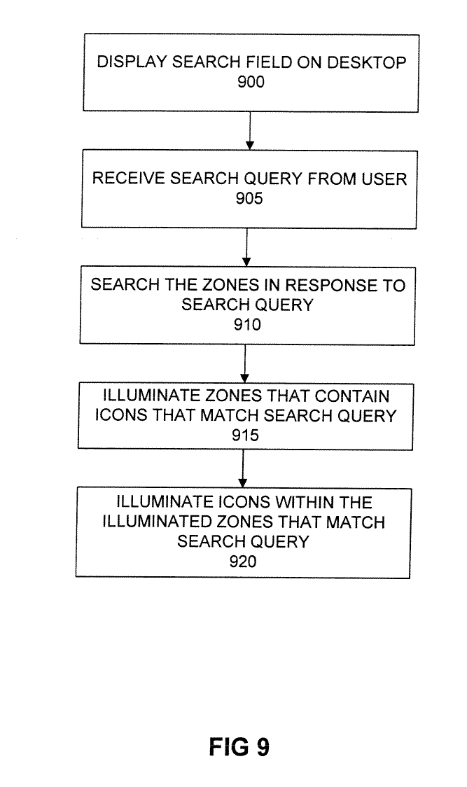

FIG. 9 is a flow diagram illustrating searching the zones for icons in response to a user search query according to one embodiment of the invention. At block 900, a search field is displayed on the desktop and control flows to block 905. With reference to FIG. 5, search field 570 is displayed on desktop 500. At block 905 the data processing system receives a search query from the user. For example, in FIG. 5 the user would input a search query into search field 570. After the search query is received control flows to block 910.

At block 910 the zones are searched in response to the search query. There are a number of ways the data processing system can handle the search query. For example, if the user is providing the search query via a keyboard, the data processing system may dynamically search the zones upon each character being entered. Additionally or alternatively, the data processing system may wait to search the zone until the search query has been entered and the user has given an additional command (e.g., mouse click, keyboard entry, etc.). After the zones are searched control flows to block 915.

At block 915, the zones that contain at least one icon matching the search query are illuminated (i.e., stand out to the user). There are a number of ways to illuminate a zone (e.g., darkened edges, fading away non-matching zones, sparks around the border of the zone, and/or any other visual cue). With reference to FIG. 5, the zone 530 is illuminated (which indicates that at least one icon within zone 530 matches the search query entered into search field 570). After the zones are illuminated, control flows to block 920 where the icons that match the search query are illuminated within the illuminated zones. Similarly to illuminating zones, there are a number of ways to illuminate icons (e.g., darkened edges, fading away non-matching icons, sparks around the border, and/or any other visual cue). With reference to FIG. 5, icon 503A is illuminated within illuminated zone 530. Thus, icon 503A matched the search query entered into search field 570. In other embodiments, a window showing the search results may be displayed rather than displaying highlighted zones.

FIG. 10 is a flow diagram illustrating launching an application with an expanded toolbar according to one embodiment of the invention. At block 1005 the toolbar is displayed on the desktop with an expansion command and subsequently control flows to block 1010. In reference to FIG. 3B, the toolbar 301, with expansion command 360, is displayed on the desktop 300. At block 1010, a subset of application icons are displayed on the toolbar. In reference to FIG. 3B, application icons 301A, 301B, and 301C are displayed on application launch portion 305 within toolbar 301. As previously discussed, typically the most commonly used applications are displayed on application launch portion 305.

At block 1015, a single command from a user is received commanding the data processing system to expand the toolbar. As previously described, the single command received from the user may be provided in any number of ways. For example, in reference to FIG. 3B, in one embodiment the single command is a position of a cursor 350 being in proximity to the expansion command 360 (e.g., within a few pixels, adjacent to, over, etc.). Alternatively, the single command could be inputted by a keyboard.

After receipt of the single command, the data processing system displays the expanded toolbar at block 1020. According to one embodiment the expanded toolbar is displayed as a window. For example, in reference to FIG. 3B, application window 309 is displayed. Application window 309 includes icons that are within application launch portion 305 (icons 301A, 301B, and 301C) and icons that are not within application launch portion (301D and 301E). Furthermore, the application icons within application window 309 are categorized according to application functionality.

After the expanded toolbar is displayed, the data processing system receives input indicating application launch at block 1025. As previously described, the input indicating application launch may be performed in a number of ways. For example, a cursor may be positioned in proximity to an application launch icon (e.g., within a few pixels, adjacent to, over, etc.) and additional input (e.g., mouse input, keyboard input, etc.) may signal application launch. Alternatively, a user may indicate application launch without using a cursor. For example, a user may ‘tab through’ the application icons in the expanded toolbar using the tab key of a keyboard (or any other predefined keyboard key assigned for this task). The currently selected icon is illuminated in such a fashion to alert the user which icon is currently selected. The user then provides additional keyboard input indicating application launch (e.g., pressing the enter key).

While the invention has been described in terms of several embodiments, those skilled in the art will recognize that the invention is not limited to the embodiments described. For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.) Thus, the method and apparatus of the invention can be practiced with modification and alteration within the spirit and scope of the appended claims. The description is thus to be regarded as illustrative instead of limiting on the invention.

What is claimed is:

1. A method for organizing and viewing information in a data processing system having a desktop, the method comprising:
creating a group according to a predefined set of rules, wherein the group contains a plurality of icons;
displaying the group on the desktop, where the group is visually identified on the desktop in a distinguishing manner; and
expanding the group to display, on the desktop, the plurality of icons within the group, while a position of a cursor is in proximity to the group or in response to a command to expand.

2. The method of claim 1 wherein the group includes icons of similar file type, temporal values, downloaded items, items to be written to media, or networked computers; and wherein the creating of the group is performed dynamically and wherein the desktop is a displayed region on a display device coupled to the data processing system and wherein the displayed region exists behind a window which is less than full size and the displayed region can receive, for display, icons representing at least one of a file, a folder and a hardware device.

3. The method of claim 1 wherein the predefined set of rules are determined by a filing system of the data processing system, and wherein the desktop provides views of files without windows, and wherein expanding the group shows the plurality of icons without creating a window.

4. The method of claim 1 wherein the group is visually identified on the desktop by a graphic, text label, color, unique shape, or any combination thereof.

5. A method of organizing and viewing information in a data processing system having a desktop and a cursor, comprising:
displaying a first and second zone on the desktop, where the first and second zones conceal icons;
adding a first plurality of icons into the first zone and a second plurality of icons into the second zone;
expanding the first zone to reveal, on the desktop, the first plurality of icons upon a position of the cursor being in proximity to the first zone; and
collapsing the first zone to conceal the first plurality of icons and expanding the second zone to reveal the second plurality of icons on the desktop upon the position of the cursor changing from being in proximity to the first zone to being in proximity of the second zone, wherein only one zone at a time can be fully expanded.

6. The method of claim 5 wherein the first and second zones are categorized by icons of similar file type, temporal values, downloaded items, items to be written to media, or networked computers.

7. The method of claim 5 wherein the first and second zones are each visually identified on the desktop by a graphic, text label, color, unique shape, or any combination thereof.

8. A method for organizing and viewing information in a data processing system having a desktop and a cursor, the method comprising:
displaying a plurality of zones, where each of the plurality of zones represents different distinguishing characteristics, and wherein one or more icons are associated with the plurality of zones corresponding to the distinguishing characteristics;
expanding one of the plurality of zones by one of a command to expand or by positioning the cursor in proximity to the one of the plurality of zones to display icons within the one of the plurality of zones; and
previewing, on the display, an item that is represented by a single icon within the one of the plurality of zones in response to a position of the cursor being in proximity to the single icon within the one of the plurality of zones or in response to a command to cause the previewing, wherein the item is one of a file or another data processing system.

9. The method of claim 8, further comprising dynamically adding icons to one or more of the plurality of zones upon icon creation and wherein the command comprises receiving a signal which indicates a switch has changed a state.

10. The method of claim 8, wherein the distinguishing characteristics of the zones are by file type, temporal values, downloaded items, items to be written to media, or networked computers.

11. The method of claim 8, wherein the plurality of zones are each visually identified on the desktop by a graphic, text label, color, unique shape, or any combination thereof.

12. The method of claim 8, further comprising opening the file that is represented by the single icon within the one of the plurality of zones upon receiving a signal from an input device while the position of the cursor is in proximity to the single icon.

13. A method of organizing and displaying information in a data processing system having a desktop, the method comprising:
displaying a first and second group on the desktop, wherein the first group includes one or more icons corresponding to a first characteristic and the second group includes one or more icons representing corresponding to a second characteristic;
adding a single icon to the first and second group, wherein the single icon is associated to a single file;
displaying the single icon in the first group while a position of a cursor is in proximity to the first group; and
displaying the single icon in the second group while the position of the cursor is in proximity to the second group.

14. The method of claim 13 wherein the first and second characteristics are similar file type, temporal values, downloaded items, items to be written to media, or networked computers.

15. The method of claim 13 wherein the first and second group are visually identified on the desktop by a graphic, text label, color, unique shape, or any combination thereof.

16. A method of launching an application on a data processing system having a desktop, comprising:
displaying a toolbar on the desktop, wherein the toolbar includes an expansion command, and wherein the toolbar is capable of displaying a subset of a plurality of application icons without activation of the expansion command;
receiving a single command from a user to expand the toolbar to display at least a portion of the plurality of application icons not in the subset of the plurality of application icons, wherein the at least the portion of the plurality of application icons are categorized according to application functionality; and
launching an application upon receiving user input indicating application launch while a position of a cursor is in proximity to an application icon in the expanded toolbar.

17. The method of claim 16, further comprising the toolbar including a hardware device launch portion, wherein one or more hardware device icons are dynamically added upon hardware device initialization.

18. The method of claim 16 wherein the application icons are icons corresponding to user-level programs, system services, or configuration programs.

19. The method of claim 16, wherein the single command received from the user is positioning a cursor in proximity to the expansion command.

20. The method of claim 16, wherein the single command received from the user is keyboard input.

21. A method of locating icons on a data processing system having a desktop, the method comprising:
displaying a search field on the desktop;
displaying one or more zones on the desktop, wherein at least one of the one or more zones contain a plurality of icons;
receiving, from a user, a search request query entered into the search field for icons within the one or more zones, wherein the one or more zones are searched corresponding to the search request query; and
illuminating zones from the one or more zones that contain at least one icon that match the search request query.

22. The method of claim 21, further comprising creating a search result zone that includes icons that match the search request query.

23. The method of claim 21, further comprising illuminating icons within the illuminated zones that match the search request query.

24. A method of launching an application on a data processing system having a desktop, the method comprising:
displaying a region of a screen that is associated with an edge of the desktop that contains at least one icon that is capable of launching applications upon user selection of the at least one icon;
receiving a single command from a user to expand the region of the screen that is associated with the edge of the desktop to display at least one different icon than is displayed on the region of the screen that is associated with the edge of the desktop;
launching the application upon,
receiving user input that positions a cursor to be in proximity of one of the icons in the expanded region of the screen, and
receiving user input indicating application launch while the position of the cursor is in proximity to the one of the icons in the expanded region of the screen.

25. The method of claim 24 further comprising the region of the screen that is associated with the edge of the desktop including a hardware device launch portion, wherein one or more hardware device icons are dynamically added upon hardware device initialization.

26. The method of claim 24, wherein the single command received from the user is positioning a cursor in proximity to an expansion command coupled to the region of the screen that is associated with the edge of the desktop.

27. The method of claim 24, wherein the single command received from the user is keyboard input.

28. A machine-readable medium that provides instructions, which when executed by a set of processors, cause said set of processors to perform operations comprising:
creating a group according to a predefined set of rules, wherein the group contains a plurality of icons;
displaying the group on a desktop, where the group is visually identified on the desktop in a distinguishing manner; and
expanding the group to display, on the desktop, the plurality of icons within the group, while a position of a cursor is in proximity to the group or in response to a command to expand.

29. The machine-readable medium of claim 28, the group includes icons of similar file type, temporal values, downloaded items, items to be written to media, or networked computers; and wherein the creating of the group is performed dynamically.

30. The machine-readable medium of claim 28 wherein the predefined set of rules are determined by a filing system of the data processing system, and wherein the desktop provides views of files without windows, and wherein expanding the group shows the plurality of icons without creating a window.

31. The machine-readable medium of claim 28 wherein the group is visually identified on the desktop by a graphic, text label, color, unique shape, or any combination thereof.

32. A machine-readable medium that provides instructions, which when executed by a set of processors, cause said set of processors to perform operations comprising:
displaying a first and second zone on a desktop, where the first and second zones conceal icons;
adding a first plurality of icons into the first zone and a second plurality of icons into the second zone;
expanding the first zone to reveal, on the desktop, the first plurality of icons upon a position of a cursor being in proximity to the first zone or in response to a command to expand; and
collapsing the first zone to conceal the first plurality of icons and expanding the second zone to reveal the second plurality of icons on the desktop upon the position of the cursor changing from being in proximity to the first zone to being in proximity of the second zone, wherein only one zone at a time can be fully expanded.

33. The machine-readable medium of claim 32 wherein the first and second zones are categorized by icons of similar file type, temporal values, downloaded items, items to be written to media, or networked computers.

34. The machine-readable medium of claim 32 wherein the first and second zones are each visually identified on the desktop by a graphic, text label, color, unique shape, or any combination thereof.

35. A machine-readable medium that provides instructions, which when executed by a set of processors, cause said set of processors to perform operations comprising:
displaying a plurality of zones, where each of the plurality of zones represents different distinguishing characteristics, and wherein one or more icons are associated with the plurality of zones corresponding to the distinguishing characteristics;
expanding one of the plurality of zones by one of a command to expand or by positioning a cursor in proximity to the one of the plurality of zones to display icons within the one of the plurality of zones; and
previewing, on a display, an item that is represented by a single icon within the one of the plurality of zones in response to a position of the cursor being in proximity to the single icon within the one of the plurality of zones or in response to a command to cause the previewing, wherein the item is one of a file or another data processing system.

36. The machine-readable medium of claim 35, further comprising dynamically adding icons to one or more of the plurality of zones upon icon creation.

37. The machine-readable medium of claim 35, wherein the distinguishing characteristics of the zones are by file type, temporal values, downloaded items, items to be written to media, or networked computers.

38. The machine-readable medium of claim 35, wherein the plurality of zones are each visually identified on the desktop by a graphic, text label, color, unique shape, or any combination thereof.

39. The machine-readable medium of claim 35, further comprising opening the file that is represented by the single icon within the one of the plurality of zones upon receiving a signal from an input device while the position of the cursor is in proximity to the single icon.

40. A machine-readable medium that provides instructions, which when executed by a set of processors, cause said set of processors to perform operations comprising:
displaying a first and second group on the desktop, wherein the first group includes one or more icons corresponding to a first characteristic and the second group includes one or more icons representing corresponding to a second characteristic;
adding a single icon to the first and second group, wherein the single icon is associated to a single file;
displaying the single icon in the first group while a position of a cursor is in proximity to the first group; and
displaying the single icon in the second group while the position of the cursor is in proximity to the second group.

41. The machine-readable medium of claim 40 wherein the first and second characteristics are similar file type, temporal values, downloaded items, items to be written to media, or networked computers.

42. The machine-readable medium of claim 40 wherein the first and second group are visually identified on the desktop by a graphic, text label, color, unique shape, or any combination thereof.

43. A machine-readable medium that provides instructions, which when executed by a set of processors, cause said set of processors to perform operations comprising:
displaying a toolbar on a desktop, wherein the toolbar includes an expansion command, and wherein the toolbar is capable of displaying a subset of a plurality of application icons without activation of the expansion command;
receiving a single command from a user to expand the toolbar to display at least a portion of the plurality of application icons not in the subset of the plurality of application icons, wherein the at least the portion of the plurality of application icons are categorized according to application functionality; and
launching an application upon receiving user input indicating application launch while a position of a cursor is in proximity to an application icon in the expanded toolbar.

44. The machine-readable medium of claim 43, further comprising the toolbar including a hardware device launch portion, wherein one or more hardware device icons are dynamically added upon hardware device initialization.

45. The machine-readable medium of claim 43, wherein the application icons are icons corresponding to user-level programs, system services, or configuration programs.

46. The machine-readable medium of claim 43, wherein the single command received from the user is positioning a cursor in proximity to the expansion command.

47. The machine-readable medium of claim 43, wherein the single command received from the user is keyboard input.

48. A machine-readable medium that provides instructions, which when executed by a set of processors, cause said set of processors to perform operations comprising:
displaying a search field on a desktop;
displaying one or more zones on the desktop, wherein at least one of the one or more zones contain a plurality of icons;
receiving, from a user, a search request query entered into the search field for icons within the one or more zones, wherein the one or more zones are searched corresponding to the search request query; and
illuminating zones from the one or more zones that contain at least one icon that match the search request query.

49. The machine-readable medium of claim 48, further comprising creating a search result zone that includes icons that match the search request query.

50. The machine-readable medium of claim 48, further comprising illuminating icons within the illuminated zones that match the search request query.

51. A machine-readable medium that provides instructions, which when executed by a set of processors, cause said set of processors to perform operations comprising:
displaying a region of a screen that is associated with an edge of a desktop that contains at least one icon that is capable of launching applications upon user selection of the at least one icon;
receiving a single command from a user to expand the region of the screen that is associated with the edge of the desktop to display at least one different icon than is displayed on the region of the screen that is associated with the edge of the desktop;
launching an application upon,
receiving user input that positions a cursor to be in proximity of one of the icons in the expanded region of the screen, and
receiving user input indicating application launch while the position of the cursor is in proximity to the one of the icons in the expanded region of the screen.

52. The machine-readable medium of claim 51 further comprising the region of the screen that is associated with the edge of the desktop including a hardware device launch portion, wherein one or more hardware device icons are dynamically added upon hardware device initialization.

53. The machine-readable medium of claim 51, wherein the single command received from the user is positioning a cursor in proximity to an expansion command coupled to the region of the screen that is associated with the edge of the desktop.

54. The machine-readable medium of claim 51, wherein the single command received from the user is keyboard input.

55. An apparatus for organizing information in a data processing system having a desktop, the apparatus comprising:
a means for displaying on the desktop one or more zones, wherein each of the one or more zones conceal a plurality of icons;
a means for adding icons into the one or more zones; and
a means for expanding the one or more zones to reveal the plurality of icons concealed within the one or more zones.
